(19) United States
(12) Patent Application Publication
(10) Pub. No.: US 2011/0304709 A1
(43) Pub. Date: Dec. 15, 2011

(54) VIDEO DISPLAY APPARATUS AND VIDEO VIEWING SYSTEM

(76) Inventors: Yoshio UMEDA, Hyogo (JP); Takahiro Kobayashi, Okayama (JP); Seiji Hamada, Osaka (JP); Satoshi Hirotsune, Hyogo (JP)

(21) Appl. No.: 13/152,712

(22) Filed: Jun. 3, 2011

(30) Foreign Application Priority Data
Jun. 9, 2010 (JP) 2010-131867

(51) Int. Cl. H04N 13/04

(52) U.S. Cl. 348/51; 348/E13.075; 348/E13.001

(57) ABSTRACT

A liquid crystal drive unit performs overdrive processing such that when driving a liquid crystal panel so as to increase a brightness toward a target brightness determined by a left-eye video signal or a right-eye video signal, the liquid crystal drive unit drives the liquid crystal panel in accordance with a drive amount corresponding to a brightness of not less than the target brightness and, when driving the liquid crystal panel so as to reduce the brightness toward the target brightness, the liquid crystal drive unit drives the liquid crystal panel in accordance with a drive amount corresponding to a brightness of not more than the target brightness. In the overdrive processing, the drive amount corresponding to the same target brightness differs depending on a scanning position on a display screen of the liquid crystal panel.

### BACKGROUND OF THE INVENTION

1. Field of the Invention

The present invention relates to a video display apparatus which displays a video image so as to allow a three-dimensional perception of the video image, and a video viewing system for viewing the video image displayed on the display apparatus.

2. Description of the Related Art

Examples of a prior-art three-dimensional display apparatus for allowing a three-dimensional video image to be obtained include a three-dimensional display apparatus which alternately supplies a left-eye video image and a right-eye video image having a parallax therebetween to a display with a predetermined period (e.g., field period), and by which the video images are observed with an eyeglass device for three-dimensional video image observation including liquid crystal shutters each driven in synchronization with the predetermined period (see, e.g., Japanese Patent Application Laid-Open Nos. Sho 62-133891 and 2009-25436).

FIG. 9 is a block diagram showing a configuration of a prior-art three-dimensional display system. A three-dimensional display system 300 shown in FIG. 9 includes a three-dimensional display apparatus 301 and an eyeglass device 302. The three-dimensional display apparatus 301 includes a three-dimensional video processing unit 101, a liquid crystal drive unit 102, a liquid crystal panel 103, a backlight 104, a left-eye shutter control circuit 105L, a right-eye shutter control circuit 105R, and a backlight control unit 106.

To the three-dimensional video processing unit 101, a left-eye video signal and a right-eye video signal each having a period of 60 Hz are input. The three-dimensional video processing unit 101 converts the left-eye video signal and the right-eye video signal each having the period of 60 Hz to a left/right video signal having a period of 120 Hz and outputs the left/right video signal to the liquid crystal drive unit 102 and the backlight control unit 106.

The liquid-crystal drive unit 102 converts the left/right video signal having the period of 120 Hz from the three-dimensional video processing unit 101 to a form that can be displayed on the liquid crystal panel 103 and then outputs it to the liquid crystal panel 103. The backlight control unit 106 generates a light emission control signal for controlling light emission from the backlight 104 based on the left/right video signal having the period of 120 Hz from the three-dimensional video processing unit 101 and outputs it to the backlight 104.

The backlight 104 illuminates the back surface of the liquid crystal panel 103 with light from behind based on the light emission control signal from the backlight control unit 106. The liquid crystal panel 103 alternately displays the left-eye video image and the right-eye video image with a period of 120 Hz.

On the other hand, the eyeglass device 302 includes a left eyeglass shutter 302L and a right eyeglass shutter 302R. The left-eye shutter control circuit 105L controls the opening/closing of the left eyeglass shutter 302L in synchronization with the left/right video signal having the period of 120 Hz from the three-dimensional video processing unit 101. The right-eye shutter control circuit 105R controls the opening/closing of the right eyeglass shutter 302R in synchronization with the left/right video signal having the frequency of 120 Hz from the three-dimensional video processing unit 101.

FIG. 10 is a view showing a control timing chart in the prior-art three-dimensional display apparatus. The control timing chart shown in FIG. 10 shows write timings for the left-eye video signal and the right-eye video signal in the liquid crystal panel 103, the types of the video signals to be written, light emission timings for the backlight 104, and opening/closing timings for the right eyeglass shutter 302R and the left eyeglass shutter 302L.

As shown in FIG. 10, in the liquid crystal panel 103, the right-eye video signal and the left-eye video signal are successively written. The backlight control unit 106 controls the backlight 104 into a constantly ON mode.

The right-eye shutter control circuit 105R controls the opening/closing of the right eyeglass shutter 302R such that a shutter open period is ¼ of a video period after scanning for writing the right-eye video signal to the liquid crystal panel 103. The left-eye shutter control circuit 105L controls the opening/closing of the left eyeglass shutter 302L such that the shutter open period is ¼ of the video period after scanning for writing the left-eye video signal to the liquid crystal panel 103. The left-eye video image and the right-eye video image through the left eyeglass shutter 302L and the right eyeglass shutter 302R are respectively input to the left and right eyes of a human being, resulting in the generation of a visual three-dimensional video image in the brain of the human being.

FIG. 11 is a view for illustrating crosstalk which occurs in the prior-art three-dimensional display apparatus. Note that FIG. 11 shows a timing chart when a video signal is written in which the right-eye video image is a white video image and the left-eye video image is a black video image in a given pixel at the middle portion of a screen.

The timing chart shown in FIG. 11 shows the brightness of an input video signal, a liquid crystal drive signal 201 which is output to the liquid crystal panel 103, a brightness response 202 of the liquid crystal panel 103, the opening/closing timings for the right eyeglass shutter 302R and the left eyeglass shutter 302L, a liquid crystal drive signal 203 which is output to the liquid crystal panel 103 at the time of overdrive processing, and a brightness response 204 of an image displayed on the liquid crystal panel 103 during the overdrive processing.

As shown in FIG. 11, to the liquid crystal panel 103, a rectangular liquid crystal drive signal 201 is output in which a white signal for a right-eye video image having a brightness level of 235 (a maximum brightness level of 255) and a black signal for a left-eye video image having a brightness level of 20 (a minimum brightness level of 0) are alternately repeated. In response thereto, the brightness response of the image displayed on the liquid crystal panel 103 gradually increases toward a target brightness level of 235 from a time when the writing of the left-eye video signal starts until a time when the writing of the left-eye video signal ends, and then gradually decreases toward a target brightness level of 20 from the time when the writing of the left-eye video signal ends (time when the writing of the right-eye video signal starts) until a time when the writing of the right-eye video signal ends.

At this time, in the open period of the right eyeglass shutter 302R, a state is provided where the brightness response 202 has not reached the liquid crystal drive signal 201 (target brightness), i.e., the brightness of the liquid crystal panel 103 has not completely changed to that for the right-eye video image which is, in other words, a state where an immediately previous left-eye video image remains. Such a phenomenon is called crosstalk, and the occurrence of the crosstalk significantly degrades the quality of a three-dimensional video image. Likewise, in the open period of the left eyeglass shutter 302L also, the brightness response 202 has not reached the liquid crystal drive signal 201 (target brightness) so that crosstalk occurs. The occurrence of the crosstalk results from the response speed of the liquid crystal panel 103. Because the response speed of the liquid crystal panel 103 to the drive voltage applied to the liquid crystal panel 103 is low, the drive voltage cannot reach the target voltage within the open period of the eyeglass shutter so that the crosstalk occurs. An amount of crosstalk showing the degree of crosstalk corresponds to the area of a portion obtained by subtracting the brightness response 202 from the liquid crystal drive signal 201 during the eyeglass open period, which is shown by hatching in FIG. 11.

FIG. 12 is a view showing a relationship between a screen vertical position and an amount of crosstalk in the prior-art three-dimensional display apparatus. As shown in FIG. 12, the amount of crosstalk increases from a screen upper portion toward a screen lower portion. To apply the drive voltage to the liquid crystal panel 103, a given time period is required, and the drive voltage is sequentially applied on a line-by-line basis from the screen upper portion toward the screen lower portion. Accordingly, the phase of a liquid crystal response waveform gradually lags from the screen upper portion toward the screen lower portion. In addition, the response of the brightness of the image displayed on the liquid crystal panel 103 approaches the target brightness with the lapse of time from the time when the video signal is written. Therefore, the amount of crosstalk in the screen lower portion is larger than the amount of crosstalk in the screen upper portion so that the amount of crosstalk increases from the screen upper portion toward the screen lower portion.

To prevent the occurrence of crosstalk, overdrive processing which applies a drive voltage higher than a target voltage to the liquid crystal panel 103 is performed to thereby allow an increase in the response speed of the liquid crystal panel 103.

The liquid crystal drive unit 102 performs the overdrive processing which applies the drive voltage higher than the target voltage to the liquid crystal panel 103. This increases the response speed of the liquid crystal panel 103 and reduces the crosstalk. In FIG. 11, the liquid crystal drive signal 203 for applying the drive voltage higher than the target voltage to the liquid crystal panel 103 is output. As a result, in the open period of the right eyeglass shutter 302R, the brightness response 204 has substantially reached the liquid crystal drive signal 203 (target brightness) and the crosstalk has decreased. On the other hand, in the open period of the left eyeglass shutter 302L, the brightness response 204 has substantially reached the liquid crystal drive signal 203 (target brightness) and crosstalk has decreased.

However, in the prior-art three-dimensional display apparatus, the overdrive processing is performed with a given drive voltage irrespective of a vertical position on the screen. FIG. 13 is a view showing a relationship between the screen vertical position and an amount of crosstalk during prior-art overdrive processing. In FIG. 13, the broken line shows am amount of crosstalk which normally occurs, and the solid line shows an amount of crosstalk which occurs during the prior-art overdrive processing.

As shown in FIG. 13, by performing the overdrive processing, the total amount of crosstalk has decreased. However, since the overdrive processing is performed with the given drive voltage, even after the overdrive processing, the amount of crosstalk has increased from the screen upper portion toward the screen lower portion so that the amount of crosstalk in the screen lower portion is larger than the amount of crosstalk in the screen upper portion. Therefore, in the prior-art overdrive processing, it is difficult to reduce crosstalk which occurs in the vertical direction of a display screen in accordance with the vertical position on the display screen, and it is particularly difficult to satisfactorily remove crosstalk which occurs in the screen lower portion.

### SUMMARY OF THE INVENTION

The present invention has been achieved in order to solve the problem described above, and an object of the present invention is to provide a video display apparatus and a video viewing system which can reduce crosstalk that occurs on a display screen in accordance with a scanning position on the display screen.

A video display apparatus according to an aspect of the present invention includes: a video display unit which displays a left-eye video image based on a left-eye video signal and a right-eye video image based on a right-eye video signal; and a drive unit which performs write scanning in accordance with a drive amount based on the left-eye video signal or the right-eye video signal to drive the video display unit, wherein the drive unit performs overdrive processing such that when driving the video display unit so as to increase a brightness toward a target brightness determined by the left-eye video signal or the right-eye video signal, the drive unit drives the video display unit in accordance with a drive amount corresponding to a brightness of not less than the target brightness and, when driving the video display unit so as to reduce the brightness toward the target brightness, the drive unit drives the video display unit in accordance with a drive amount corresponding to a brightness of not more than the target brightness, and in the overdrive processing, the drive amount corresponding to the same target brightness differs depending on a scanning position on a display screen of the video display unit.

In accordance with the arrangement, the video display unit displays the left-eye video image based on the left-eye video signal and the right-eye video image based on the right-eye video signal, and the drive unit performs the write scanning in accordance with the drive amount based on the left-eye video signal or the right-eye video signal to drive the video display unit. The overdrive processing is performed such that when the video display unit is driven so as to increase the brightness toward the target brightness determined by the left-eye video signal or the right-eye video signal, the video display unit is driven in accordance with the drive amount corresponding to the brightness of not less than the target brightness and, when the video display unit is driven so as to reduce the brightness toward the target brightness, the video display unit is driven in accordance with the drive amount corresponding to the brightness of not more than the target brightness. At this time, in the overdrive processing, the drive amount corresponding to the same target brightness differs depending on the scanning position on the display screen of the video display unit.

### BRIEF DESCRIPTION OF THE DRAWINGS

FIG. 1 is a block diagram showing a configuration of a three-dimensional display system according to Embodiment 1 of the present invention;

FIG. 2 is a view showing a control timing chart in the three-dimensional display system of Embodiment 1;

FIG. 3 is a view for illustrating overdrive processing in a three-dimensional display apparatus of Embodiment 1;

FIG. 4 is a view for illustrating another example of the overdrive processing in Embodiment 1;

FIG. 5 is a view showing a relationship between a screen vertical position and an amount of crosstalk during the overdrive processing of Embodiment 1;

FIG. 6 is a view showing a control timing chart in a three-dimensional display system of Embodiment 2 of the present invention;

FIG. 7 is a view for illustrating overdrive processing in a three-dimensional display apparatus of Embodiment 2;

FIG. 8 is a view showing a relationship between a screen vertical position and an amount of crosstalk during the overdrive processing of Embodiment 2;

FIG. 9 is a block diagram showing a configuration of a prior-art three-dimensional display system;

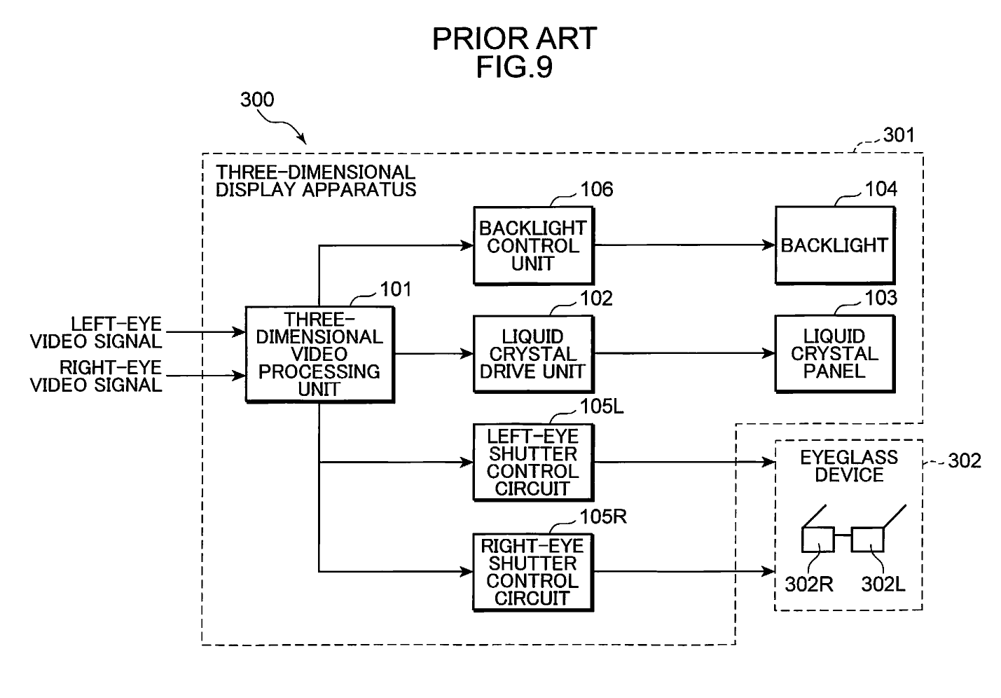

FIG. 10 is a view showing a control timing chart in a prior-art three-dimensional display apparatus;

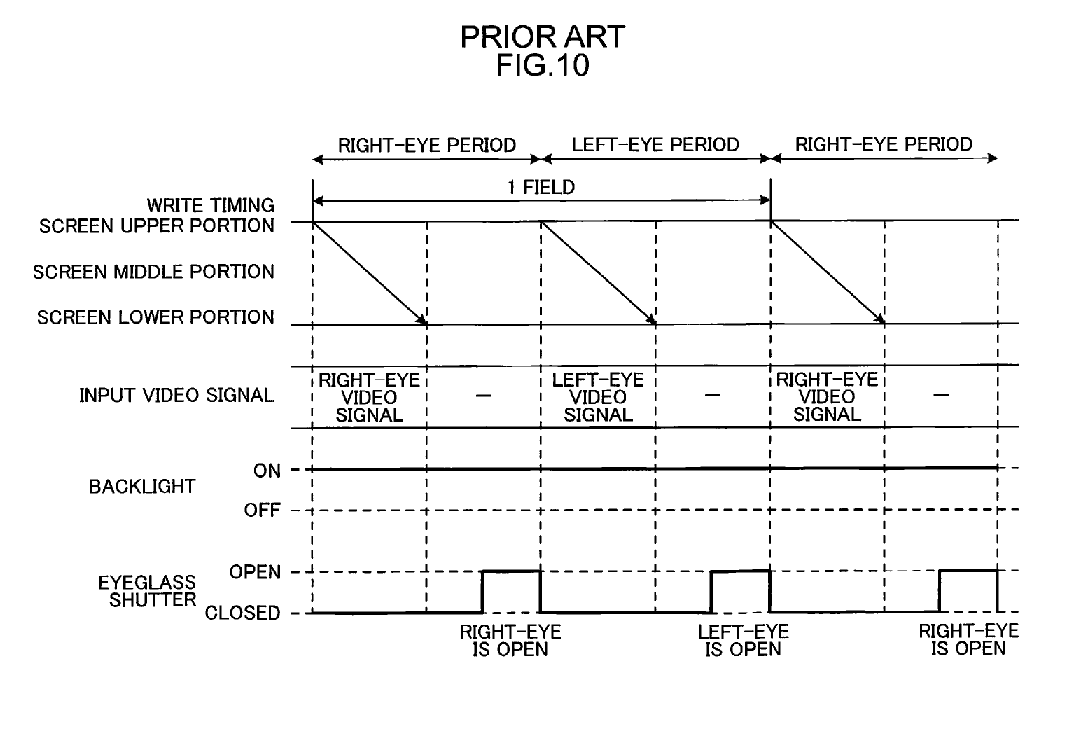

FIG. 11 is a view for illustrating crosstalk which occurs in the prior-art three-dimensional display apparatus;

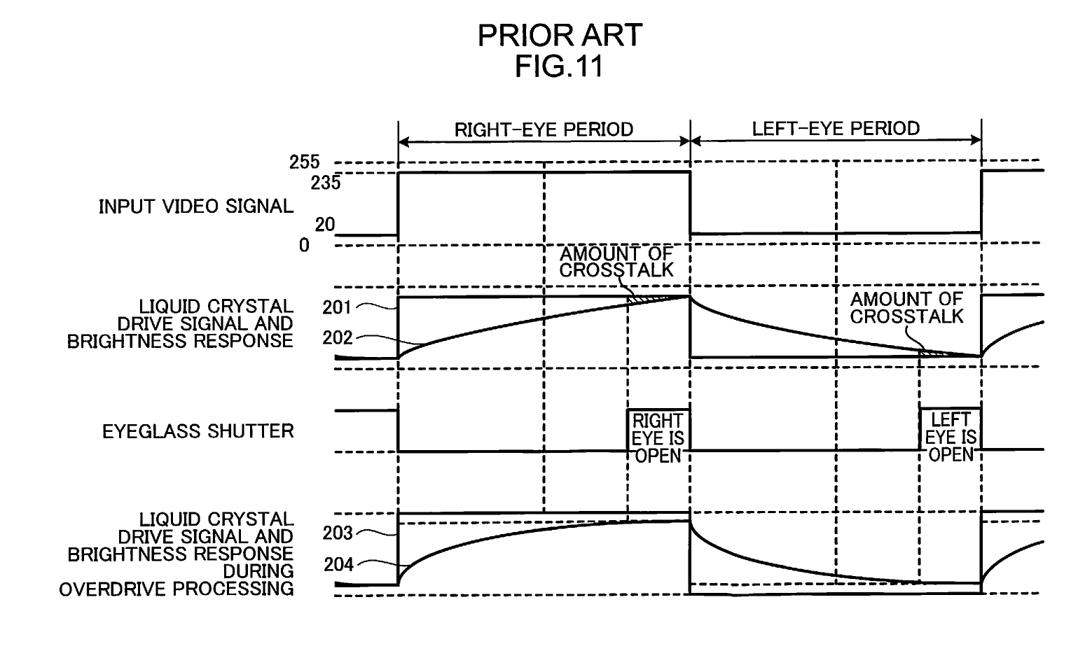

FIG. 12 is a view showing a relationship between a screen vertical position and an amount of crosstalk in the prior-art three-dimensional display apparatus; and

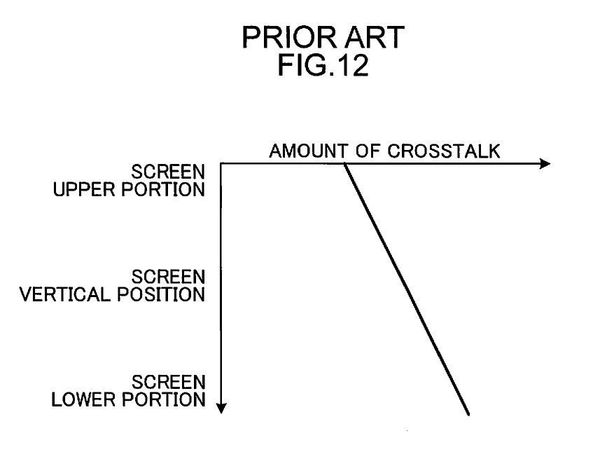

FIG. 13 is a view showing the relationship between the screen vertical position and an amount of crosstalk during prior-art overdrive processing.

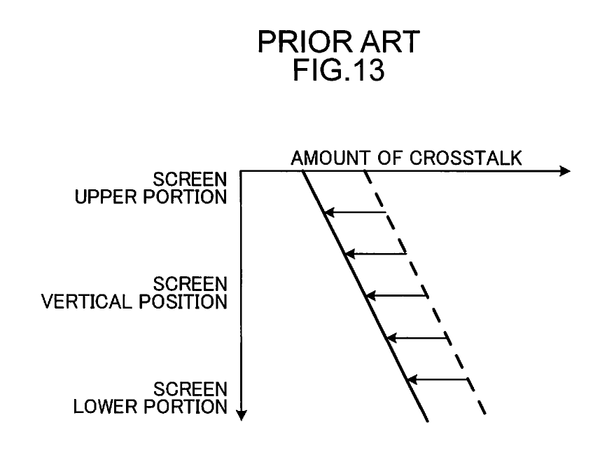

### DETAILED DESCRIPTION OF THE INVENTION

Referring now to the accompanying drawings, embodiments of the present invention will be described below. Note that each of the following embodiments is an example in which the present invention is embodied, and is not intended by nature to limit the technical scope of the present invention.

### Embodiment 1

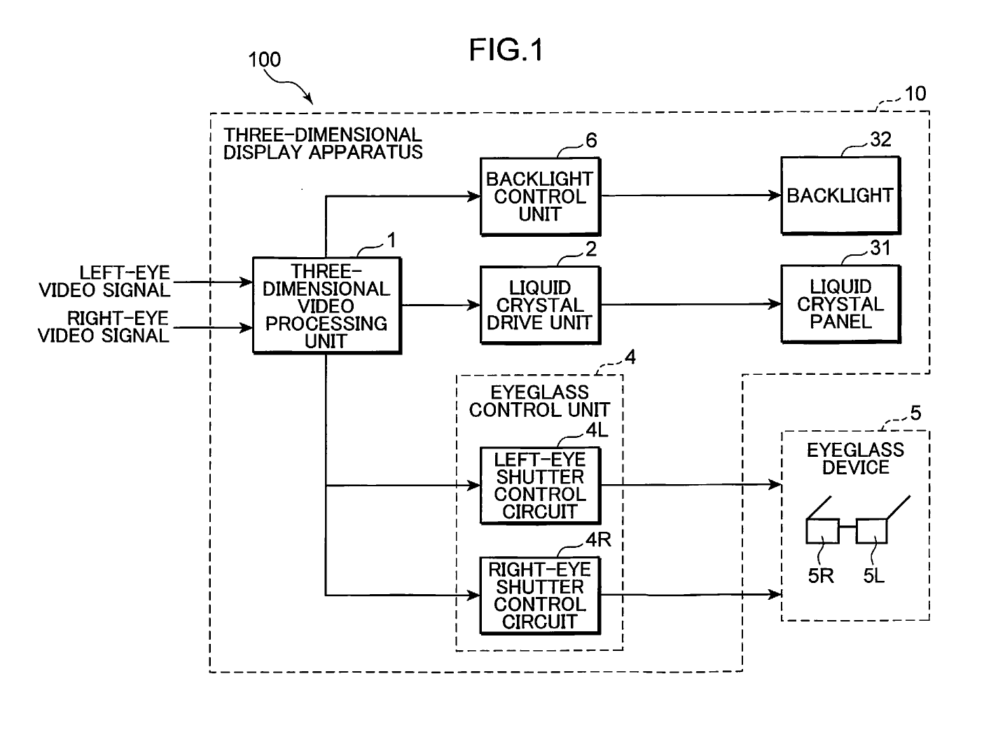

FIG. 1 is a block diagram showing a configuration of a three-dimensional display system according to Embodiment 1 of the present invention. A three-dimensional display system 100 shown in FIG. 1 includes a three-dimensional display apparatus 10 and an eyeglass device 5. The eyeglass device 5 includes a left eyeglass shutter 5L which adjusts an amount of light that reaches the left eye of a viewer and a right eyeglass shutter 5R which adjusts an amount of light that reaches the right eye of the viewer. The three-dimensional display apparatus 10 controls the open/closed states of the left eyeglass shutter 5L and the right eyeglass shutter 5R in accordance with a left-eye video image and a right-eye video image.

The three-dimensional display apparatus 10 includes a three-dimensional video processing unit 1, a liquid crystal drive unit 2, a liquid crystal panel 31, a backlight 32, an eyeglass control unit 4, and a backlight control unit 6.

To the three-dimensional video processing unit 1, a left-eye video signal and a right-eye video signal each having a fundamental vertical synchronization frequency are input. The three-dimensional processing unit 1 converts each of the left-eye video signal and the right-eye video signal that have been input with a frequency which is N times (N is a positive integer of not less than 1) the fundamental vertical synchronization frequency to a left/right video signal in which the left-eye video signals and the right-eye video signals are alternately arranged, and outputs the left/right video signal. In the present embodiment, the three-dimensional video processing unit 1 converts the input left-eye video signal and right eye signal each having a period of 60 Hz to the left/right video signal (left-eye video signal and right-eye video signal) having a period of 120 Hz, and outputs the left/right video signal to each of the liquid crystal drive unit 2, the eyeglass control unit 4, and the backlight control unit 6. Note that, as necessary, the three-dimensional video processing unit 1 need not output all of the left-eye video signals and the right-eye video signals. For example, the three-dimensional video processing unit 1 may also output only a synchronization signal at a 120 Hz frequency to the eyeglass control unit 4.

The liquid crystal drive unit 2 performs write scanning in accordance with a drive amount based on the left-eye video signal or the right-eye video signal to drive the liquid crystal panel 31. The liquid crystal drive unit 2 converts the left/right video signal having the period of 120 Hz to a form that can be displayed on the liquid crystal panel 31. The liquid crystal drive unit 2 outputs the left/right video signal resulting from the conversion to the liquid crystal panel 31.

In each of a period during which the left-eye video signal is written within a 1-field period and a period during which the right-eye video signal is written within the 1-field period, the liquid crystal drive unit 2 performs overdrive processing such that when driving the liquid crystal panel 31 so as to increase the brightness toward a target brightness, the liquid crystal drive unit 2 drives the liquid crystal panel 31 in accordance with a drive amount (applied voltage) corresponding to a brightness of not less than the target brightness and, when driving the liquid crystal panel 31 so as to reduce the brightness toward the target brightness, the liquid crystal drive unit 2 drives the liquid crystal panel 31 in accordance with a drive amount corresponding to a brightness of not more than the target brightness. At this time, in the overdrive processing, a drive amount corresponding to the same target brightness differs depending on a scanning position on the display screen of the liquid crystal panel 31. The liquid-crystal drive unit 2 applies a drive voltage which differs depending on a vertical position on the display screen of the liquid crystal panel 31 to the liquid crystal panel 31.

The liquid crystal panel 31 modulates light incident thereon from behind in accordance with the input left-eye video signal and right-eye video signal, and successively displays the left-eye video image based on the left-eye video signal and the right-eye video image based on the right-eye video signal. To the liquid crystal panel 31, any of panels using various drive methods such as an IPS (In Plane Switching) method, a VA (Vertical Alignment) method, and a TN (Twisted Nematic) method can be applied. The liquid crystal panel 31 and the backlight 32 are an example of a video display unit. As the video display unit, an organic EL panel may also be used.

The backlight 32 illuminates the back surface of the liquid crystal panel 31 with light from behind. The backlight 32 performs plane light emission using a plurality of light emitting diodes (LEDs) arranged in two dimensions. Note that the backlight 32 may also perform plane light emission by arranging and disposing a plurality of fluorescent tubes. Otherwise, the backlight 32 may also be of an edge type in which light emitting diodes or fluorescent tubes are arranged on an end portion, and is not limited to the present embodiment.

The backlight 32 emits light based on a light emission control signal output from the backlight control unit 6. Note that, in Embodiment 1, the backlight 32 is held in a constantly ON mode.

The eyeglass control unit 4 controls the open/closed state of each of the left eyeglass shutter 5L and the right eyeglass shutter 5R of the eyeglass device 5 in an open/close cycle according to the display cycle of each of the left-eye video signal and the right-eye video signal. The eyeglass control unit 4 generates an eyeglass control signal for controlling, for the eyeglass device 5 which alternately transmits light to the right eye and to the left eye based on the left-eye video signal and the right-eye video signal, switching between the transmission of light to the right eye and the transmission of light to the left eye. In the present embodiment, the display cycle of the left-eye video signal and the right-eye video signal is 120 Hz so that the eyeglass control unit 4 controls the open/close cycle of each of the left eyeglass shutter 5L and the right eyeglass shutter 5R with 60 Hz. The eyeglass control unit 4 has a left-eye shutter control circuit 4L and a right-eye shutter control circuit 4R.

Each of the left-eye shutter control circuit 4L and the right-eye shutter control circuit 4R determines a phase in a shutter open period using a 120 Hz synchronization signal for the left/right video signal as a reference. The left-eye shutter control circuit 4L generates, in synchronization with the left/right video signal, a left eyeglass control signal for controlling the transmission of light to the left eye. The right-eye shutter control circuit 4R generates, in synchronization with the left/right video signal, a right eyeglass control signal for controlling the transmission of light to the right eye. By output signals from the left-eye shutter control circuit 4L and the right-eye shutter control circuit 4R, the open/closed states of the left eyeglass shutter 5L and the right eyeglass shutter 5R are controlled.

The eyeglass control unit 4 sets, in consideration of the response characteristic of the liquid crystal panel 31 and inter-image crosstalk between the left-eye video image and the right-eye video image, a pulse width and shutter open/close positions (phase in the shutter open period) in the open period of each of the left eyeglass shutter 5L and the right eyeglass shutter 5R. In the present embodiment, the pulse width of each of the left eyeglass shutter 5L and the right eyeglass shutter 5R is 25% (25% Duty) of one cycle period (16.7 msec) of the video signal having the period of 60 Hz, and the closed positions of the left eyeglass shutter 5L and the right eyeglass shutter 5R are assumed to be the respective terminal positions of left-eye and right-eye video signal scanning periods. The shutter open/close positions are controlled by the left-eye shutter control circuit 4L and the right-eye shutter control circuit 4R.

The backlight control unit 6 outputs a light emission control signal for causing the backlight 32 to constantly emit light. Note that the backlight control unit 6 may also operate based on the 120 Hz synchronization signal from the three-dimensional video processing unit 1 and output a light emission control signal for causing the backlight 32 to emit light in synchronization with the open/close positions of the left eyeglass shutter 5L and the right eyeglass shutter 5R.

Note that, in Embodiment 1, the three-dimensional display system 100 corresponds to an example of a video viewing system, the three-dimensional display apparatus 10 corresponds to an example of a video display apparatus, the eyeglass device 5 corresponds to an example of an eyeglass device, the liquid crystal panel 31 and the backlight 32 correspond to an example of a video display unit, the liquid crystal drive unit 2 corresponds to an example of a drive unit, and the eyeglass control unit 4 corresponds to an example of an eyeglass control unit.

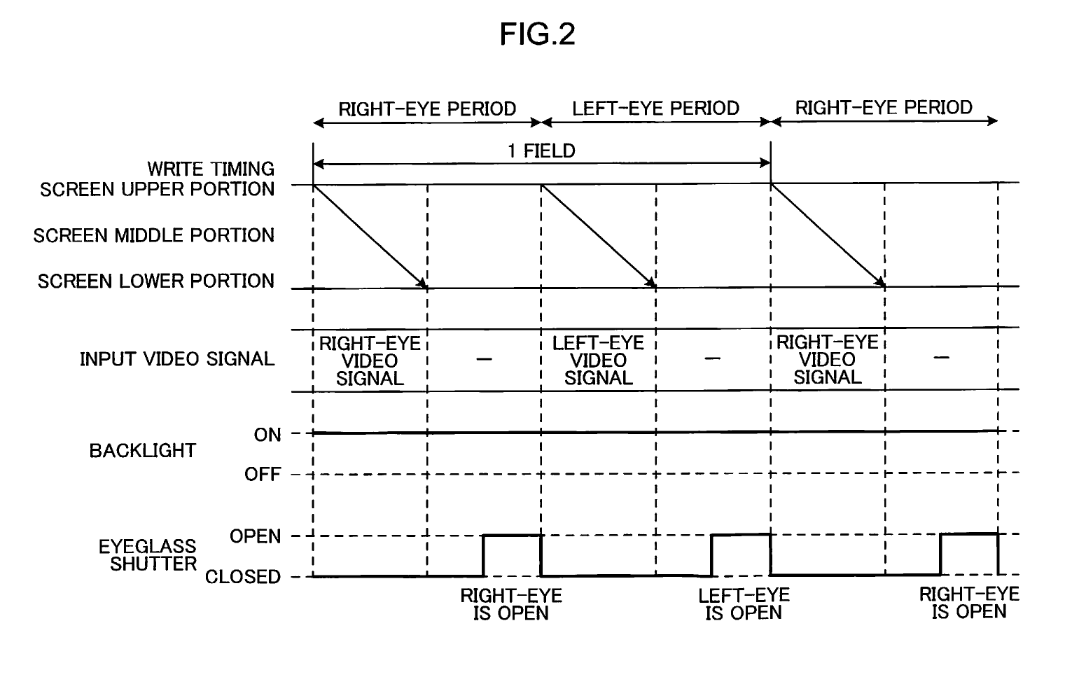

FIG. 2 is a view showing a control timing chart in the three-dimensional display system of Embodiment 1. The control timing chart shown in FIG. 2 shows write timings for the left-eye video signal and the right-eye video signal in the liquid crystal panel 31, the types of video signals to be written, light emission timings for the backlight 32, and open/close timings for the right eyeglass shutter 5R and the left eyeglass shutter 5L.

Here, as shown by the write timings, to the liquid crystal panel 31, the right-eye video signal or the left-eye video signal is sequentially written from a screen upper portion to a screen lower portion. In the case of Embodiment 1, writing is completed in a time which is about ¼ of the period of 1 field (60 Hz=16.7 msec). The backlight control unit 6 controls the backlight 32 into a constantly ON mode.

The right-eye shutter control circuit 4R controls the opening/closing of the right eyeglass shutter 5R such that, after scanning for writing the right-eye video signal to the liquid crystal panel 31, the open period of the shutter is ¼ of a video period. The left-eye shutter control circuit 4L controls the opening/closing of the left eyeglass shutter 5L such that, after scanning for writing the left-eye video signal to the liquid crystal panel 31, the open period of the shutter is ¼ of the video period. The left-eye video image and the right-eye video image through the left eyeglass shutter 5L and the right eyeglass shutter 5R are respectively input to the left and right eyes of a human being, resulting in the generation of a visual three-dimensional video image in the brain of the human being.

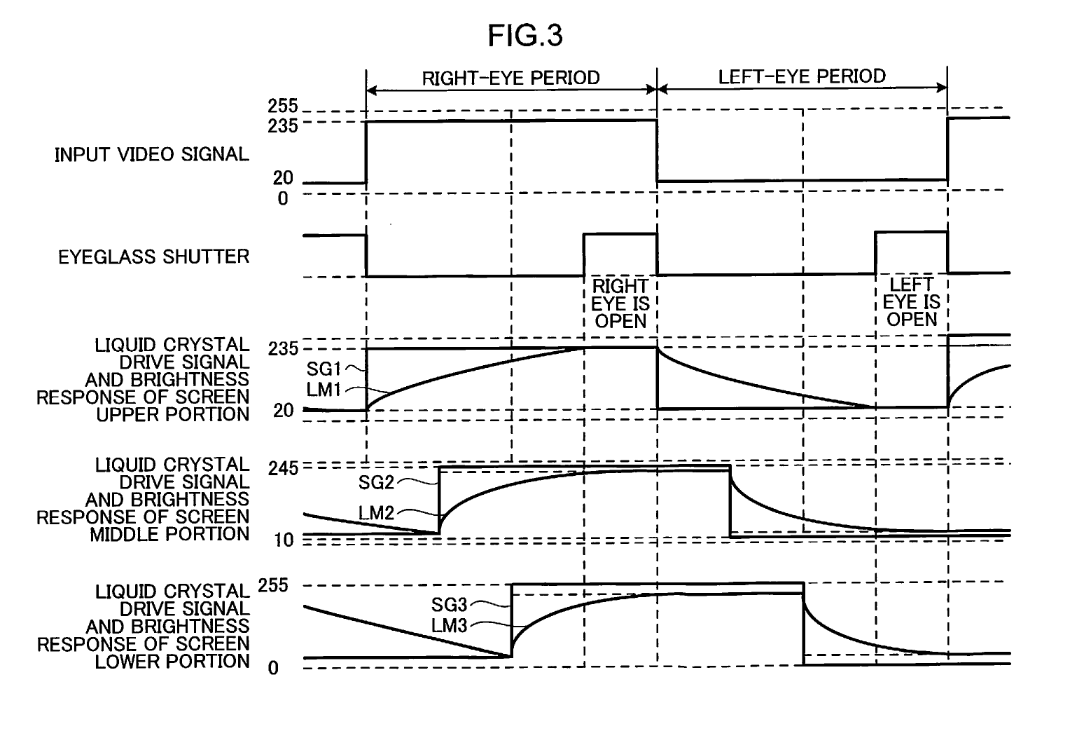

FIG. 3 is a view for illustrating overdrive processing in the three-dimensional display apparatus of Embodiment 1.

The timing chart shown in FIG. 3 shows the brightness of an input video signal, open/close timings for the right eyeglass shutter 5R and the left eyeglass shutter 5L, a liquid crystal drive signal SG1 which is output to the screen upper portion of the liquid crystal panel 31, a brightness response LM1 of the screen upper portion of the liquid crystal panel 31, a liquid crystal drive signal SG2 output to a screen middle portion of the liquid crystal panel 31, a brightness response LM2 of the screen middle portion of the liquid crystal panel 31, a liquid crystal drive signal SG3 output to the screen lower portion of the liquid crystal panel 31, and a brightness response LM3 of the screen lower portion of the liquid crystal panel 31. Note that each of the brightness responses is equivalent to the response of the transmittance of the liquid crystal panel 31 when the light from the backlight 32 is constant.

The three-dimensional video processing unit 1 outputs the right-eye video signal having a brightness of 235 and also outputs the left-eye video signal having a brightness of 20. The right-eye video signal and the left-eye video signal are input to the liquid crystal drive unit 2.

The liquid crystal drive unit 2 drives the liquid crystal panel 31 so as to control the transmittance in accordance with a drive amount based on each of the left-eye video signal and the right-eye video signal. In each of the period during which the left-eye video signal is written within the 1-field period and the period during which the right-eye video signal is written within the 1-field period, the liquid crystal drive unit 2 performs overdrive processing such that when performing driving so as to increase the transmittance of the liquid crystal panel 31 toward the target brightness, the liquid crystal drive unit 2 drives the liquid crystal panel 31 in accordance with a drive amount (applied voltage) corresponding to a transmittance required for a brightness of not less than the target brightness and, when performing driving so as to reduce the transmittance of the liquid crystal panel 31 toward the target brightness, the liquid crystal drive unit 2 drives the liquid crystal panel 31 in accordance with a drive amount corresponding to a transmittance required for a brightness of not more than the target brightness. When performing the overdrive processing, even for the same target brightness, the liquid crystal drive unit 2 applies a drive voltage which differs depending on a vertical scanning position on the display screen of the liquid crystal panel 31.

When performing the overdrive processing, the liquid crystal drive unit 2 performs the overdrive processing such that the difference between the applied voltage corresponding to the target brightness determined by the left-eye video signal or the right-eye video signal and the applied voltage with which the overdrive processing has been performed is larger at a scanning position which is scanned after a position where vertical scanning of the liquid crystal panel 31 starts, than at the scanning start position. That is, in Embodiment 1, the liquid crystal drive unit 2 gradually increases the difference between the applied voltage corresponding to the target brightness and the applied voltage with which the overdrive processing has been performed from the screen upper portion of the liquid crystal panel 31 toward the screen lower portion thereof.

In addition, the liquid crystal drive unit 2 preferably varies the drive amount in accordance with which driving is performed in the overdrive processing according to the timing to switch light for the eyeglass device 5 in response to the eyeglass control signal generated by the eyeglass control unit 4.

The period during which the left-eye video signal is written and the period during which the right-eye video signal is written include first periods from the initiation of the writing of the left-eye video signal and the right-eye video signal until the completion thereof and second periods subsequent to the first periods. The eyeglass control unit 4 controls the eyeglass device 5 so as to open the left eyeglass shutter 5L and the right eyeglass shutter 5R during the second periods. The liquid crystal drive unit 2 causes the brightness of the liquid crystal panel 31 to reach the target brightness during the periods during which the left eyeglass shutter 5L and the right eyeglass shutter 5R are open. Note that the liquid crystal drive unit 2 preferably causes the brightness of the liquid crystal panel 31 to reach the target brightness before the left eyeglass shutter 5L and the right eyeglass shutter 5R open.

Note that the liquid crystal drive unit 2 may also set a drive voltage applied in the overdrive processing for each of pixels in the vertical direction of the display screen or, alternatively, may also divide the display screen into a plurality of regions in a vertical direction and set the drive voltage applied in the overdrive processing for each of the regions resulting from the division.

As shown in FIG. 3, in the screen upper portion, the liquid crystal drive unit 2 outputs the liquid crystal drive signal SG1 for applying a target voltage (voltage corresponding to the brightness level of 235 and the brightness level of 20) for displaying a video image corresponding to the video signal. In the screen upper portion, there is a time margin between a time when the writing of the right-eye video signal starts and a time when the right eyeglass shutter 5R opens. Accordingly, the liquid crystal drive unit 2 need not perform the overdrive processing.

In the screen middle portion, the liquid crystal display unit 2 outputs the liquid crystal drive signal SG2 for applying a first drive voltage (voltage corresponding to a brightness level of 245) higher than the target voltage. This increases the response speed of the liquid crystal panel 31 and reduces crosstalk. In FIG. 3, in the open period of the right eyeglass shutter 5R, the brightness response LM2 has reached the liquid crystal drive signal SG2 (target brightness) and the crosstalk has decreased. On the other hand, in the open period of the left eyeglass shutter 5L, the liquid crystal drive unit 2 outputs the liquid crystal drive signal SG2 for applying a second drive voltage (voltage corresponding to a brightness level of 10) lower than the target voltage. As a result, the brightness response LM2 has reached the liquid crystal drive signal SG2 (target brightness) and the crosstalk has decreased.

In the screen lower portion, the liquid crystal drive unit 2 outputs the liquid crystal drive signal SG3 for applying a third drive voltage (voltage corresponding to a brightness level of 255) higher than the target voltage and also higher than the first drive voltage. As a result, the response speed of the liquid crystal panel 31 increases and crosstalk decreases. In FIG. 3, in the open period of the right eyeglass shutter 5R, the brightness response LM3 has reached the liquid crystal drive signal SG3 (target brightness) and the crosstalk has decreased. On the other hand, in the open period of the left eyeglass shutter 5L, the liquid crystal drive unit 2 outputs the liquid crystal drive signal SG2 for applying a fourth drive voltage (voltage corresponding to a brightness level of 0) lower than the target voltage and also lower than the second drive voltage. As a result, the brightness response LM3 has reached the liquid crystal drive signal SG3 (target brightness) and the crosstalk has decreased.

Also, for example, the liquid crystal drive unit 2 stores in advance a table in which a vertical position on the screen is associated with an increment in the set drive voltage in the overdrive processing. The liquid crystal drive unit 2 reads the increment in the set drive voltage corresponding to the vertical position on the screen where the video signal is to be written from the table, and adds the read increment to the set drive voltage to perform the overdrive processing.

Note that the liquid crystal drive unit 2 may also store in advance a table in which each of the uppermost, middle, and lowermost portions of the display screen is associated with an increment in the set drive voltage in the overdrive processing. In this case, the liquid crystal drive unit 2 may also calculate an increment in the set drive voltage at a position between the uppermost and middle portions and an increment in the set drive voltage at a position between the middle and lowermost portions by performing interpolation.

In the present embodiment, the liquid crystal drive unit 2 stores the table in advance, but the present invention is not particularly limited thereto. It may also be possible to calculate the set drive voltage which increases as the vertical position on the screen moves from the upper portion thereof to the lower portion thereof based on a predetermined calculating formula.

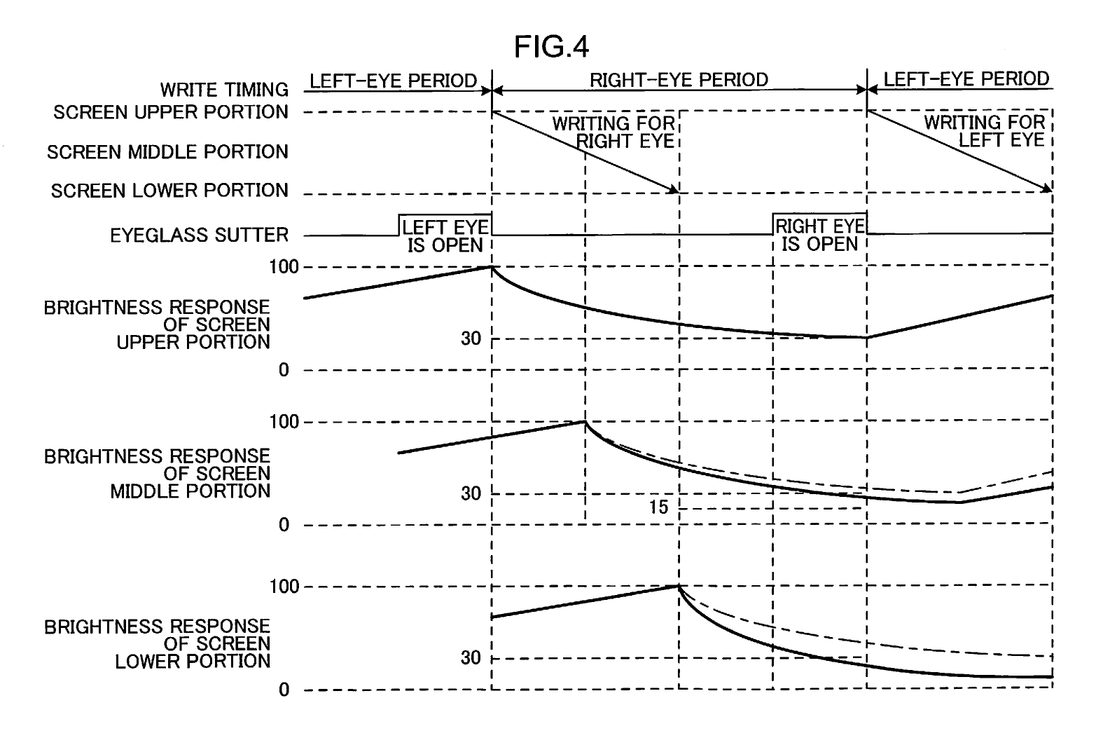

Next, a description will be given of another example of the overdrive processing in Embodiment 1. FIG. 4 is a view for illustrating another example of the overdrive processing in Embodiment 1.

The timing chart shown in FIG. 4 shows write timings for the left-eye video signal and the right-eye video signal in the liquid crystal panel 31, open/close timings for the right eyeglass shutter 5R and the left eyeglass shutter 5L, the brightness response of the screen upper portion of the liquid crystal panel 31, the brightness response of the screen middle portion of the liquid crystal panel 31, and the brightness response of the screen lower portion of the liquid crystal panel 31.

As shown in FIG. 4, when, e.g., the brightness of the left-eye video signal in the previous frame is 100, the brightness of the right-eye video signal in the current frame is 30, and a video image is written in the screen upper portion, the liquid crystal drive unit 2 performs the overdrive processing on the assumption that a set brightness value (set drive voltage) is 30. As a result, in writing for the right eye, the brightness of the liquid crystal panel 31 is reduced from 100 to 30. At this time, the brightness in the current frame has reached 30, which is the target brightness (target drive voltage). In the screen upper portion, there is a time margin between the time when the writing of the right-eye video signal starts and the time when the right eyeglass shutter 5R opens. Accordingly, a gain value (Target Brightness Value-Set Brightness Value) in the overdrive processing is sufficient if it is 0, and the liquid crystal drive unit 2 need not perform the overdrive processing.

Otherwise, when, e.g., the brightness of the left-eye video signal in the previous frame is 100, the brightness of the right-eye video signal in the current frame is 30, and the right-eye video signal is written in the screen middle portion, the liquid crystal drive unit 2 performs the overdrive processing on the assumption that the set brightness value is 15. As a result, in the writing for the right eye, the brightness of the liquid crystal panel 31 is reduced from 100 to 30. At this time, the brightness in the current frame has reached 30, which is the target brightness. In the screen middle portion, a period from the time when the writing of the right-eye video signal starts until the time when the right eyeglass shutter 5R opens is shorter than in the screen upper portion. Therefore, the liquid crystal drive unit 2 needs to perform the overdrive processing, and the gain value (Target Brightness Value-Set Brightness Value) in the overdrive processing is set to 15.

In the screen middle portion, an amount of crosstalk which occurs when the overdrive processing is not performed is represented by the area of the region between the brightness response (the dash-dot line of FIG. 4) when the overdrive processing is not performed and a brightness value of 30 in the right-eye open period. Also, an amount of crosstalk which occurs when the overdrive processing is performed is represented by the area of the region between the brightness response (the solid line of FIG. 4) when the overdrive processing is performed and the brightness value of 30 in the right-eye open period. As shown in FIG. 4, the amount of crosstalk which occurs when the overdrive processing is performed has obviously decreased to be smaller than the amount of crosstalk which occurs when the overdrive processing is not performed.

Otherwise, when, e.g., the brightness of the left-eye video signal in the previous frame is 100, the brightness of the right-eye video signal in the current frame is 30, and a video image is written in the screen lower portion, the liquid crystal drive unit 2 performs the overdrive processing on the assumption that the set brightness value is 0. As a result, in the writing for the right eye, the brightness of the liquid crystal panel 31 is reduced from 100 to 30. At this time, the brightness in the current frame has reached 30, which is the target brightness. In the screen lower portion, the period from the time when the writing of the right-eye video signal starts until the time when the right eyeglass shutter 5R opens is shorter than in the screen middle portion. Therefore, the liquid crystal drive unit 2 needs to perform the overdrive processing with a drive voltage higher than in the screen middle portion, and the gain value (Target Brightness Value-Set Brightness Value) in the overdrive processing is set to 30.

In the screen lower portion, an amount of crosstalk which occurs when the overdrive processing is not performed is represented by the area of the region between the brightness response (the dash-dot line of FIG. 4) when the overdrive processing is not performed and the brightness value of 30 in the right-eye open period. Also, an amount of crosstalk which occurs when the overdrive processing is performed is represented by the area of the region between the brightness response (the solid line of FIG. 4) when the overdrive processing is performed and the brightness value of 30 in the right-eye open period. As shown in FIG. 4, the amount of crosstalk which occurs when the overdrive processing is performed has obviously decreased to be smaller than the amount of crosstalk which occurs when the overdrive processing is not performed.

By thus varying the drive voltage applied in the overdrive processing in accordance with the vertical position on the screen, it is possible to prevent the brightness of the liquid crystal panel 31 from not reaching the target brightness and reduce the occurrence of crosstalk.

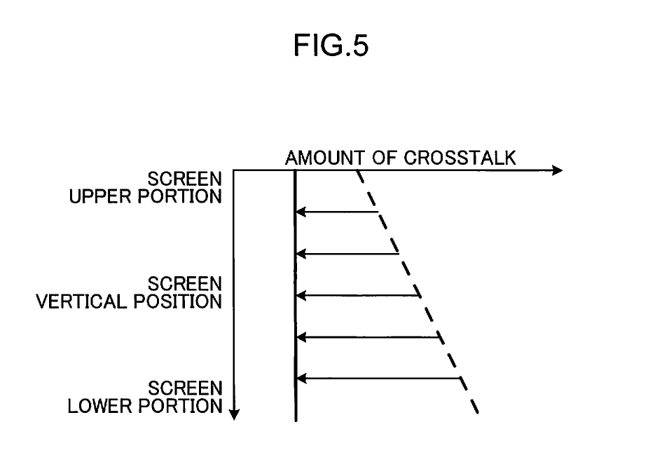

FIG. 5 is a view showing a relationship between the screen vertical position and an amount of crosstalk during the overdrive processing of Embodiment 1. In FIG. 5, the broken line shows the amount of crosstalk which normally occurs, and the solid line shows the amount of crosstalk which occurs during the overdrive processing of Embodiment 1.

As shown in FIG. 5, by performing the overdrive processing, the total amount of crosstalk has decreased. In addition, in Embodiment 1, the drive voltage applied in the overdrive processing for the same target brightness value is varied in accordance with the vertical position on the screen. This allows a reduction in the difference between the amount of crosstalk in the screen upper portion and the amount of crosstalk in the screen lower portion. Therefore, it is possible to reduce crosstalk that occurs in the vertical direction of the display screen in accordance with the vertical position on the display screen.

### Embodiment 2

Next, a three-dimensional display system according to Embodiment 2 of the present invention will be described. Embodiment 2 is different from Embodiment 1 in the operation of the backlight control unit 6. The components of the three-dimensional display system according to Embodiment 2 is the same as in Embodiment 1, and therefore a description will be given using FIG. 1.

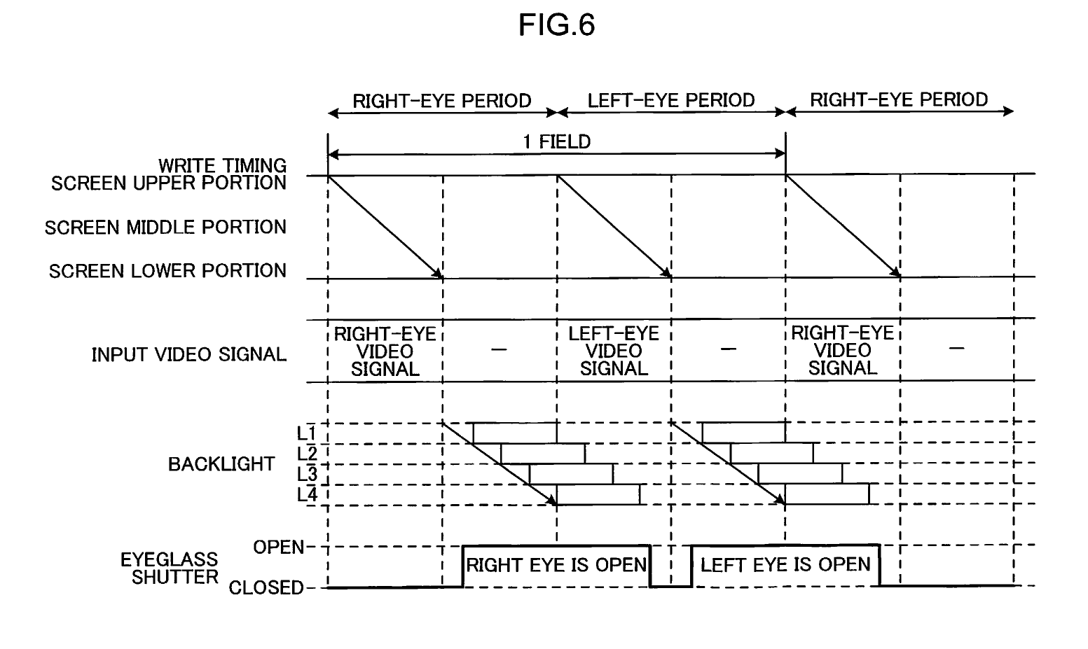

FIG. 6 is a view showing a control timing chart in the three-dimensional display system of Embodiment 2. The control timing chart shown in FIG. 6 shows write timings for a left-eye video signal and a right-eye video signal in the liquid crystal panel 31, the types of video signals to be written, light emission timings for the backlight 32, and open/close timings for the right eyeglass shutter 5R and the left eyeglass shutter 5L.

The backlight 32 is lit in synchronization with a left/right video signal having a period of 120 Hz. The backlight 32 is divided in a vertical direction from a screen upper portion to a screen lower portion into four regions (hereinafter referred to as “scan layers”), and each of the scan layers is individually lit. As shown in FIG. 6, the scan layers are assumed successively to be a first scan layer L1, a second scan layer L2, a third scan layer L3, and a fourth scan layer L4 from the scan layer in the screen upper portion in descending order. The back light control unit 6 individually controls a light emission timing and a lighting brightness for each of the scan layers of the backlight 32.

Note that, in Example 2, the backlight 32 is divided into the four scan layers, but the present invention is not particularly limited thereto. The backlight 32 may also be divided into two scan layers, three scan layers, or five or more scan layers.

Here, light emission from the backlight 32 in Embodiment 2 will be described in detail. As shown in FIG. 6, the writing of the video signal to the liquid crystal panel 31 is performed from the screen upper portion. The liquid crystal layer begins to respond, in response to the writing of the video signal, first in the region in the screen upper portion, and successively begins to respond in lower screen regions in descending order. That is, the screen upper portion switches accordingly earlier to the right-eye video image or to the left-eye video image.

To write the right-eye video signal, the backlight control unit 6 lights the first scan layer L1 of the backlight 32 in a period from a time when the reaction of the liquid crystal layer at a screen position corresponding to the first scan layer L1 is completed until a time when the writing of the left-eye video signal is initiated at the same screen position corresponding to the first scan layer L1. The right-eye shutter control circuit 4R controls the right eyeglass shutter 5R such that it opens during the period in which the first scan layer L1 is lit, while the left-eye shutter control circuit 4L controls the left eyeglass shutter 5L such that it is closed during the period in which the first scan layer L1 is lit. In this manner, the right-eye video image in the first scan layer L1 having no crosstalk reaches the right eye.

For the second scan layer L2, the third scan layer L3, and the fourth scan layer L4 also, the same processing as described above is performed. That is, as shown in FIG. 6, the backlight control unit 6 lights each of the scan layers of the backlight 32 from a time when writing to the liquid crystal panel 31 is completed at a screen position corresponding to each of the scan layers and the response of the liquid crystal at each screen position is completed. This allows a video image having no crosstalk to be displayed at the screen position corresponding to each of the scan layers. In this case, it becomes possible to elongate a lighting period compared with that in Embodiment 1 in which the entire screen is simultaneously illuminated. As a result, the effect of increasing the brightness of a three-dimensional video image viewed by a viewer is also achieved.

The operation of thus dividing the backlight 32 into the plurality of regions and successively lighting each of the regions is called a backlight scan. By successively repeating the writing of the right-eye video signal followed by the backlight scan and the writing of the left-eye video signal followed by the backlight scan, it becomes possible to display a bright high-quality three-dimensional video image with less crosstalk.

Note that, in the backlight scan, as shown in FIG. 6, it is necessary to keep open the right eyeglass shutter 5R or the left eyeglass shutter 5L at least from a time when the backlight scan starts (time when the lighting of the first scan layer L1 starts) until a time when the backlight ends (time when the lighting of the fourth scan layer L4 ends).

Here, the liquid crystal drive unit 2 varies a drive amount (drive voltage) in overdrive processing in the individual regions (scan layers) illuminated by the backlight 32. The liquid crystal drive unit 2 performs the overdrive processing such that, in each of the regions, the difference between a drive amount (applied drive voltage) corresponding to a target brightness determined by the left-eye video signal or the right-eye video signal and a drive amount in accordance with which the overdrive processing has been performed is larger at a scanning position scanned after a position where the vertical scanning of the liquid crystal panel 31 starts, than at the scanning start position. In the present embodiment, the liquid crystal drive unit 2 performs the overdrive processing such that the difference between the drive amount corresponding to the target brightness and the drive amount in accordance with which the overdrive processing has been performed is larger in a vertically lower portion of each of the scan layers than in a vertically upper portion thereof.

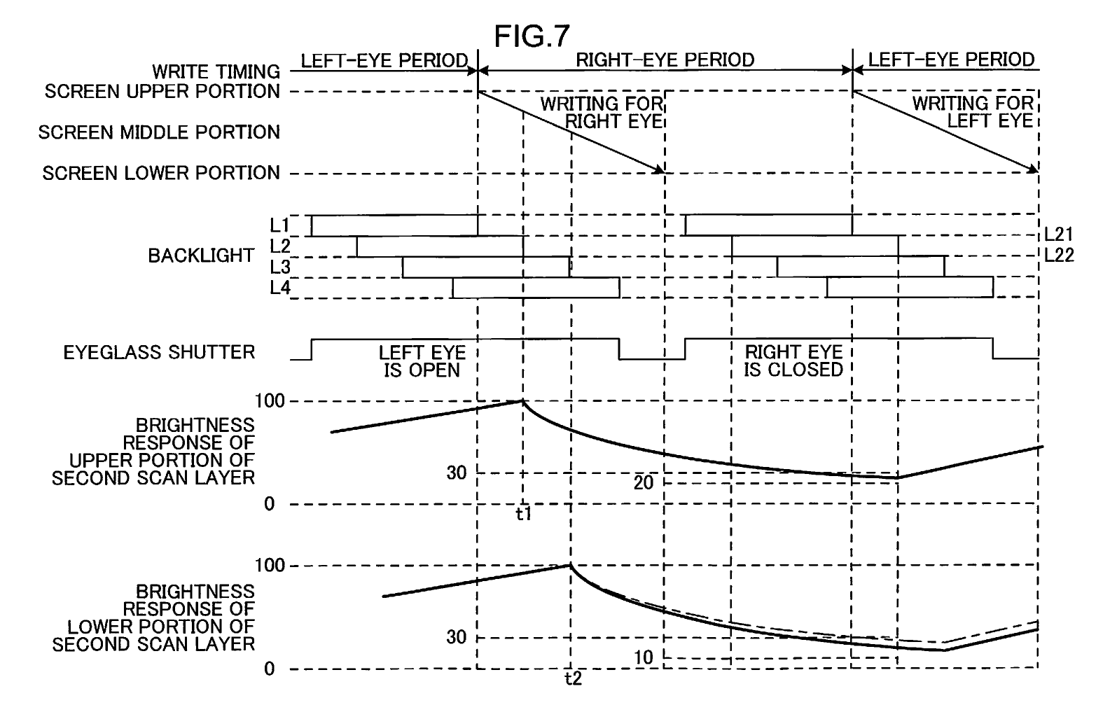

FIG. 7 is a view for illustrating the overdrive processing in a three-dimensional display apparatus of Embodiment 2.

The timing chart shown in FIG. 7 shows write timings for the left-eye video signal and the right-eye video signal in the liquid crystal panel 31, light emission timings for the backlight 32, open/close timings for the right eyeglass shutter 5R and the left eyeglass shutter 5L, the brightness response of the liquid crystal panel 31 corresponding to an upper portion L21 of the second scan layer L2, and the brightness response of the liquid crystal panel 31 corresponding to a lower portion L22 of the second scan layer L2. Note that a time t1 represents a time when the writing of the right-eye video signal to the liquid crystal panel 31 corresponding to the upper portion L21 of the second scan layer L2 starts and a time t2 represents a time when the writing of the right-eye video signal to the liquid crystal panel 31 corresponding to the lower portion L22 of the second scan layer L2 starts.

As shown in FIG. 7, when the brightness of the left-eye video signal in the previous frame is 100, the brightness of the right-eye video signal in the current frame is 30, and the right-eye video signal is written to a position corresponding to the upper portion L21 of the second scan layer L2, the liquid crystal drive unit 2 performs the overdrive processing on the assumption that the set brightness value is 20. As a result, in the writing for the right eye, the brightness of the liquid crystal panel 31 is reduced from 100 to 30. At this time, the brightness at the position corresponding to the upper portion L21 of the second scan layer L2 has reached 30, which is the target brightness, and a gain value (Target Value-Set Value) in the overdrive processing is set to 10.

Otherwise, when, e.g., the brightness of the left-eye video signal in the previous frame is 100, the brightness of the right-eye video signal in the current frame is 30, and the right-eye video signal is written to a position corresponding to the lower portion L22 of the second scan layer L2, the liquid crystal drive unit 2 performs the overdrive processing on the assumption that the set brightness value is 10. As a result, in the writing for the right eye, the brightness of the liquid crystal panel 31 is reduced from 100 to 30. At this time, the brightness at the position corresponding to the lower portion L22 of the second scan layer L2 has reached 30, which is the target brightness, and the gain value (Target Value-Set Value) in the overdrive processing is set to 20.

In the lower portion L22 of the second scan layer L2, an amount of crosstalk which occurs when the overdrive processing is performed with the same drive voltage as used for the upper portion L21 of the second scan layer L2 is represented by the area of the region between the brightness response (the dash-dot line of FIG. 7) when the overdrive processing is performed with the same drive voltage as used for the upper portion L21 of the second scan layer L2 and a brightness value of 30 in the lighting period of the second scan layer L2. Also, an amount of crosstalk which occurs when the overdrive processing is performed with a drive voltage higher than used for the upper portion L21 of the second scan layer L2 is represented by the area of the region between the brightness response (the solid line of FIG. 7) when the overdrive processing is performed with the drive voltage higher than that used for the upper portion L21 of the second scan layer L2 and the brightness value of 30 in the lighting period of the second scan layer L2. As shown in FIG. 7, the amount of crosstalk which occurs when the overdrive processing is performed in the lower portion L22 of the scan layer L2 has obviously decreased to be smaller than the amount of crosstalk which occurs when the overdrive processing is performed with the same drive voltage as used for the upper portion L21 of the second scan layer L2.

By thus varying the drive voltage applied in the overdrive processing in the individual scan layers illuminated by the backlight 32, it is possible to prevent the brightness of the liquid crystal panel 31 from decreasing to be lower than the target brightness and from not reaching the target brightness, and also reduce the occurrence of crosstalk.

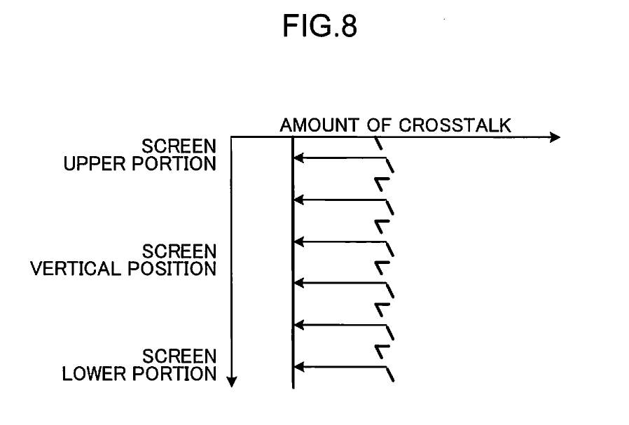

FIG. 8 is a view showing the relationship between a screen vertical position and an amount of crosstalk during the overdrive processing in Embodiment 2. In FIG. 8, the broken line shows an amount of crosstalk which normally occurs, and the solid line shows an amount of crosstalk which occurs during the overdrive processing of Embodiment 2.

As shown in FIG. 8, by performing the overdrive processing, the total amount of crosstalk has decreased. In addition, in Embodiment 2, the drive voltage applied in the overdrive processing is varied in accordance with the vertical position on the screen. As a result, the amount of crosstalk in the screen upper portion is the same as the amount of crosstalk in the screen lower portion, and it is possible to reduce crosstalk that occurs in the vertical direction of the display screen in accordance with the vertical position on the display screen.

Note that, in the specific embodiments described above, the invention having the following configuration is mainly included.

A video display apparatus according to an aspect of the present invention includes: a video display unit which displays a left-eye video image based on a left-eye video signal and a right-eye video image based on a right-eye video signal; and a drive unit which performs write scanning in accordance with a drive amount based on the left-eye video signal or the right-eye video signal to drive the video display unit, wherein the drive unit performs overdrive processing such that when driving the video display unit so as to increase a brightness toward a target brightness determined by the left-eye video signal or the right-eye video signal, the drive unit drives the video display unit in accordance with a drive amount corresponding to a brightness of not less than the target brightness and, when driving the video display unit so as to reduce the brightness toward the target brightness, the drive unit drives the video display unit in accordance with a drive amount corresponding to a brightness of not more than the target brightness, and in the overdrive processing, the drive amount corresponding to the same target brightness differs depending on a scanning position on a display screen of the video display unit.

In accordance with the arrangement, the video display unit displays the left-eye video image based on the left-eye video signal and the right-eye video image based on the right-eye video signal, while the drive unit performs the write scanning in accordance with the drive amount based on the left-eye video signal or the right-eye video signal to drive the video display unit. The overdrive processing is performed such that when the video display unit is driven so as to increase the brightness toward the target brightness determined by the left-eye video signal or the right-eye video signal, the video display unit is driven in accordance with the drive amount corresponding to the brightness of not less than the target brightness and, when the video display unit is driven so as to reduce the brightness toward the target brightness, the video display unit is driven in accordance with the drive amount corresponding to the brightness of not more than the target brightness. At this time, in the overdrive processing, the drive amount corresponding to the same target brightness differs depending on the scanning position on the display screen of the video display unit.

In thus performing the overdrive processing which drives the video display unit in accordance with the drive amount corresponding to the brightness of not less than the target brightness when driving the video display unit so as to increase the brightness toward the target brightness determined by the left-eye video signal or the right-eye video signal and drives the video display unit in accordance with the drive amount corresponding to the brightness of not more than the target brightness when driving the video display unit so as to reduce the brightness toward the target brightness, in the overdrive processing, the drive amount corresponding to the same target brightness differs depending on the scanning position on the display screen of the video display unit. Therefore, it is possible to cause the brightness of each of the left-eye video image and the right-eye video image which are displayed on the video display unit to reach the target brightness, and reduce crosstalk which occurs on the display screen in accordance with the scanning position on the display screen.

In the video display apparatus described above, the drive unit preferably performs the overdrive processing such that a difference between the drive amount corresponding to the target brightness and the drive amount in accordance with which the overdrive processing has been performed is larger at a scanning position which is scanned after a position where vertical scanning of the video display unit starts, than at the scanning start position.

In accordance with the arrangement, the overdrive processing is performed such that the difference between the drive amount corresponding to the target brightness and the drive amount in accordance with which the overdrive processing has been performed is larger at the scanning position which is scanned after the position where the vertical scanning of the video display unit starts, than at the scanning start position.

Therefore, crosstalk which occurs at the scanning position which is scanned after the scanning start position can be reduced to be smaller in amount than crosstalk which occurs at the scanning start position.

In the video display apparatus described above, it is preferable that the video display unit has a liquid crystal panel portion which modulates light incident thereon from behind in accordance with the left-eye video signal and the right-eye video signal to display the left-eye video image based on the left-eye video signal and the right-eye video image based on the right-eye video signal, and a backlight which illuminates a back surface of the liquid crystal panel portion with light, the drive unit drives the liquid crystal panel portion so as to control a transmittance in accordance with a drive amount based on each of the left-eye video signal and the right-eye video signal, and the overdrive processing drives, when driving the liquid crystal panel portion so as to increase the transmittance toward the target brightness, the liquid crystal panel portion in accordance with a drive amount corresponding to a transmittance of not less than a transmittance required for the target brightness and drives, when driving the liquid crystal panel portion so as to reduce the transmittance toward the target brightness, the liquid crystal panel portion in accordance with a drive amount corresponding to a transmittance of not more than the transmittance required for the target brightness.

In accordance with the arrangement, the liquid crystal panel portion is driven so as to control the transmittance in accordance with the drive amount based on each of the left-eye video signal and the right-eye video signal. In addition, in the overdrive processing, when the liquid crystal panel portion is driven so as to increase the transmittance toward the target brightness in the overdrive processing, the liquid crystal panel portion is driven in accordance with the drive amount corresponding to the transmittance of not less than the transmittance required for the target brightness and, when the liquid crystal panel portion is driven so as to reduce the transmittance toward the target brightness in the overdrive processing, the liquid crystal panel portion is driven in accordance with the drive amount corresponding to the transmittance of not more than the transmittance required for the target brightness.

Thus, when the liquid crystal panel portion is driven so as to increase the transmittance toward the target brightness, the liquid crystal panel portion is driven in accordance with the drive amount corresponding to the transmittance of not less than the transmittance required for the target brightness and, when the liquid crystal panel portion is driven so as to reduce the transmittance toward the target brightness, the liquid crystal panel portion is driven in accordance with the drive amount corresponding to the transmittance of not more than the transmittance required for the target brightness. Therefore, it is possible to cause the brightness of each of the left-eye video image and the right-eye video image which are displayed on the video display unit to reach the target brightness and reduce the crosstalk which occurs on the display screen in accordance with the scanning position on the display screen.

In the video display apparatus described above, it is preferable that the backlight illuminates each of regions resulting from division of the display screen in a vertical direction, and the drive unit varies the drive amount in the overdrive processing in the individual regions illuminated by the backlight.

In accordance with the arrangement, the backlight illuminates each of the regions resulting from the division of the display screen in the vertical direction, and the drive unit varies the drive amount in the overdrive processing in the individual regions illuminated by the backlight.

Thus, the drive amount in the overdrive processing is varied in the individual regions resulting from the division of the display screen in the vertical direction, and therefore it is possible to reduce crosstalk which occurs in the vertical direction of the display screen in accordance with the vertical scanning position of the display screen.

In the video display apparatus described above, the drive unit preferably performs the overdrive processing such that, in each of the regions, a difference between the drive amount corresponding to the target brightness and the drive amount in accordance with which the overdrive processing has been performed is larger at a scanning position which is scanned after a position where vertical scanning of the liquid crystal panel portion starts, than at the scanning start position.

In accordance with the arrangement, the drive unit performs the overdrive processing such that, in each of the regions, the difference between the drive amount corresponding to the target brightness and the drive amount in accordance with which the overdrive processing has been performed is larger at the scanning position which is scanned after the position where the vertical scanning of the liquid crystal panel portion starts, than at the scanning start position.

Therefore, in each of the regions resulting from the division of the display screen in the vertical direction, crosstalk which occurs at the scanning position scanned after the scanning start position can be reduced to be smaller in amount than crosstalk which occurs at the scanning start position.

Preferably, the video display apparatus described above further includes: an eyeglass control unit which generates an eyeglass control signal for controlling, for an eyeglass device which alternately transmits light to a right eye and to a left eye based on the left-eye video signal and the right-eye video signal, switching between the transmission of light to the right eye and the transmission of light to the left eye, wherein the drive unit varies the drive amount in accordance with which the driving is performed in the overdrive processing, according to a timing to switch light for the eyeglass device in response to the eyeglass control signal generated by the eyeglass control unit.

In accordance with the arrangement, the eyeglass control unit generates the eyeglass control signal for controlling, for the eyeglass device which alternately transmits light to the right eye and to the left eye based on the left-eye video signal and the right-eye video signal, the switching between the transmission of light to the right eye and the transmission of light to the left eye. In addition, the drive unit varies the drive amount in accordance with which the driving is performed in the overdrive processing according to the timing to switch light for the eyeglass device in response to the eyeglass control signal.

Thus, the drive amount in accordance with which the driving is performed in the overdrive processing is varied according to the timing to switch light for the eyeglass device. Therefore, by causing the brightness of the video display unit to reach the target brightness during the period during which light is transmitted to the left eye or the right eye, crosstalk can be reduced.

A video viewing system according to another aspect of the present invention includes: any of the video display apparatus described above; and an eyeglass device including a left-eye shutter which adjusts an amount of light that reaches a left eye of a viewer and a right-eye shutter which adjusts an amount of light that reaches a right eye of the viewer.

In accordance with the arrangement, the video display unit displays the left-eye video image based on the left-eye video signal and the right-eye video image based on the right-eye video signal, while the drive unit performs the write scanning in accordance with the drive amount based on the left-eye video signal or the right-eye video signal to drive the video display unit. The overdrive processing is performed such that when the video display unit is driven so as to increase the brightness toward the target brightness determined by the left-eye video signal or the right-eye video signal, the video display unit is driven in accordance with the drive amount corresponding to the brightness of not less than the target brightness and, when the video display unit is driven so as to reduce the brightness toward the target brightness, the video display unit is driven in accordance with the drive amount corresponding to the brightness of not more than the target brightness. At this time, in the overdrive processing, the drive amount corresponding to the same target brightness differs depending on the scanning position on the display screen of the video display unit.

In thus performing the overdrive processing which drives the video display unit in accordance with the drive amount corresponding to the brightness of not less than the target brightness when driving the video display unit so as to increase the brightness toward the target brightness determined by the left-eye video signal or the right-eye video signal and drives the video display unit in accordance with the drive amount corresponding to the brightness of not more than the target brightness when driving the video display unit so as to reduce the brightness toward the target brightness, in the overdrive processing, the drive amount corresponding to the same target brightness differs depending on the scanning position on the display screen of the video display unit. Therefore, it is possible to cause the brightness of each of the left-eye video image and the right-eye video image which are displayed on the video display unit to reach the target brightness, and reduce crosstalk which occurs on the display screen in accordance with the scanning position on the display screen.

The video display apparatus according to the present invention can reduce crosstalk which occurs on a display screen in accordance with a scanning position on the display screen, and is useful as a video display apparatus which displays a video image so as to allow a three-dimensional perception of the video image and a video viewing system for viewing the video image displayed on the display apparatus.

This application is based on Japanese Patent Application No. 2010-131867 filed on Jun. 9, 2010, the contents of which are hereby incorporated by reference.

Note that the specific embodiments or examples given in Detailed Description of the Invention are intended only to clarify the technical contents of the present invention. The present invention is not to be limited to these specific examples and construed in a narrow sense, but can be implemented with various modifications within the spirit of the present invention and the scope of the following claims.

What is claimed is:

1. A video display apparatus, comprising:
a video display unit which displays a left-eye video image based on a left-eye video signal and a right-eye video image based on a right-eye video signal; and
a drive unit which performs write scanning in accordance with a drive amount based on the left-eye video signal or the right-eye video signal to drive the video display unit, wherein
the drive unit performs overdrive processing such that when driving the video display unit so as to increase a brightness toward a target brightness determined by the left-eye video signal or the right-eye video signal, the drive unit drives the video display unit in accordance with a drive amount corresponding to a brightness of not less than the target brightness and, when driving the video display unit so as to reduce the brightness toward the target brightness, the drive unit drives the video display unit in accordance with a drive amount corresponding to a brightness of not more than the target brightness, and
in the overdrive processing, the drive amount corresponding to the same target brightness differs depending on a scanning position on a display screen of the video display unit.

2. The video display apparatus according to claim 1, wherein the drive unit performs the overdrive processing such that a difference between the drive amount corresponding to the target brightness and the drive amount in accordance with which the overdrive processing has been performed is larger at a scanning position which is scanned after a position where vertical scanning of the video display unit starts, than at the scanning start position.

3. The video display apparatus according to claim 1, wherein
the video display unit has a liquid crystal panel portion which modulates light incident thereon from behind in accordance with the left-eye video signal and the right-eye video signal to display the left-eye video image based on the left-eye video signal and the right-eye video image based on the right-eye video signal, and a backlight which illuminates a back surface of the liquid crystal panel portion with light,
the drive unit drives the liquid crystal panel portion so as to control a transmittance in accordance with a drive amount based on each of the left-eye video signal and the right-eye video signal, and
the overdrive processing drives, when driving the liquid crystal panel portion so as to increase the transmittance toward the target brightness, the liquid crystal panel portion in accordance with a drive amount corresponding to a transmittance of not less than a transmittance required for the target brightness and drives, when driving the liquid crystal panel portion so as to reduce the transmittance toward the target brightness, the liquid crystal panel portion in accordance with a drive amount corresponding to a transmittance of not more than the transmittance required for the target brightness.

4. The video display apparatus according to claim 3, wherein
the backlight illuminates each of regions resulting from division of the display screen in a vertical direction, and
the drive unit varies the drive amount in the overdrive processing in the individual regions illuminated by the backlight.

5. The video display apparatus according to claim 4, wherein the drive unit performs the overdrive processing such that, in each of the regions, a difference between the drive amount corresponding to the target brightness and the drive amount in accordance with which the overdrive processing has been performed is larger at a scanning position which is scanned after a position where vertical scanning of the liquid crystal panel portion starts, than at the scanning start position.

6. The video display apparatus according to claim 1, further comprising:
an eyeglass control unit which generates an eyeglass control signal for controlling, for an eyeglass device which alternately transmits light to a right eye and to a left eye based on the left-eye video signal and the right-eye video signal, switching between the transmission of light to the right eye and the transmission of light to the left eye, wherein
the drive unit varies the drive amount in accordance with which the driving is performed in the overdrive processing, according to a timing to switch light for the eyeglass device in response to the eyeglass control signal generated by the eyeglass control unit.

7. A video viewing system, comprising:
the video display apparatus according to claim 1; and
an eyeglass device including a left-eye shutter which adjusts an amount of light that reaches a left eye of a viewer and a right-eye shutter which adjusts an amount of light that reaches a right eye of the viewer.
